(19) United States
(12) Patent Application Publication
(10) Pub. No.: US 2022/0164943 A1
(43) Pub. Date: May 26, 2022

(54) CIRCUIT BOARD DETECTION METHOD AND ELECTRONIC DEVICE

(71) Applicants: HONGFUJIN PRECISION ELECTRONICS (CHENGDU) Co., Ltd., Chengdu (CN); HON HAI PRECISION INDUSTRY CO., LTD., New Taipei (TW)

(72) Inventors: ZI-QING XIA, Chengdu (CN); HONG WU, Chengdu (CN); YI-KUN WANG, Chengdu (CN); OU-YANG LI, Chengdu (CN); CHAO HUANG, Chengdu (CN); SU-RONG ZHU, Chengdu (CN); MIN CHEN, Chengdu (CN); JIA-HE NING, Chengdu (CN); ZHONG-SHU CHEN, Chengdu (CN)

(21) Appl. No.: 17/158,304

(22) Filed: Jan. 26, 2021

(30) Foreign Application Priority Data
Nov. 25, 2020 (CN) 202011345653.5

(51) Int. Cl. G06T 7/00

(52) U.S. Cl. CPC G06T 7/0004; G06T 2207/20084; G06T 2207/30141

(57) ABSTRACT

A circuit board detection method includes obtaining an input circuit board image, performing a detection on designated components of a circuit board in the circuit board image according to a preset detection method, determining whether a designated component in the circuit board image that fails the detection is allowed to shift within a preset angle range, and determining that the circuit board passes the detection when the designated component that fails the detection is allowed to shift within the preset angle range. The designated components include one or both of silkscreened components and non-silkscreened components.

### FIELD

The subject matter herein generally relates to circuit board detection, and more particularly to a circuit board detection method and an electronic device implementing the circuit board detection method.

### BACKGROUND

In a production process of printed circuit boards, appearance detection methods are used to detect whether there are appearance defects in a silkscreen region of the circuit board and electronic components. At present, computer vision, such as OpenCV, is generally used to detect the appearance of circuit boards. Detection items include color extraction, brightness detection, component positioning, and so on. However, detection parameters of the computer vision are usually set in advance, and during the circuit board detection process, detection results cannot be re-judged in time and effectively. Therefore, it is difficult to ensure a detection accuracy.

### BRIEF DESCRIPTION OF THE DRAWINGS

Implementations of the present disclosure will now be described, by way of embodiments, with reference to the attached figures.

FIG. 1 is a schematic diagram of an application environment architecture of a circuit board detection method according to an embodiment of the present disclosure.

FIG. 2 is a flowchart of a circuit board detection method according to an embodiment of the present disclosure.

FIG. 3 is a schematic diagram of a detection process of non-silkscreened components in a circuit board image according to an embodiment of the present disclosure.

FIG. 4 is a schematic block diagram of a circuit board detection system according to an embodiment of the present disclosure.

FIG. 5 is a schematic block diagram of an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series, and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

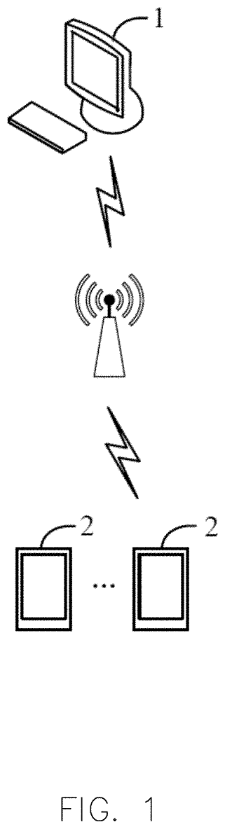

FIG. 1 shows a schematic diagram of an application environment architecture of a circuit board detection method according to an embodiment of the present disclosure.

The circuit board detection method is applied to an electronic device 1. The electronic device 1 establishes a communication connection with at least one terminal device 2 through a network. The network may be a wired network or a wireless network, such as radio, wireless fidelity (WIFI), cellular, satellite, broadcast, etc. The cellular network can be a 4G network or a 5G network, for example.

The electronic device 1 may be an electronic device, such as a personal computer, a server, etc., installed with a circuit board detection program. The server may be a single server, a server cluster, a cloud server, or the like.

The terminal device 2 may be a smart phone, a personal computer, a wearable device, or the like.

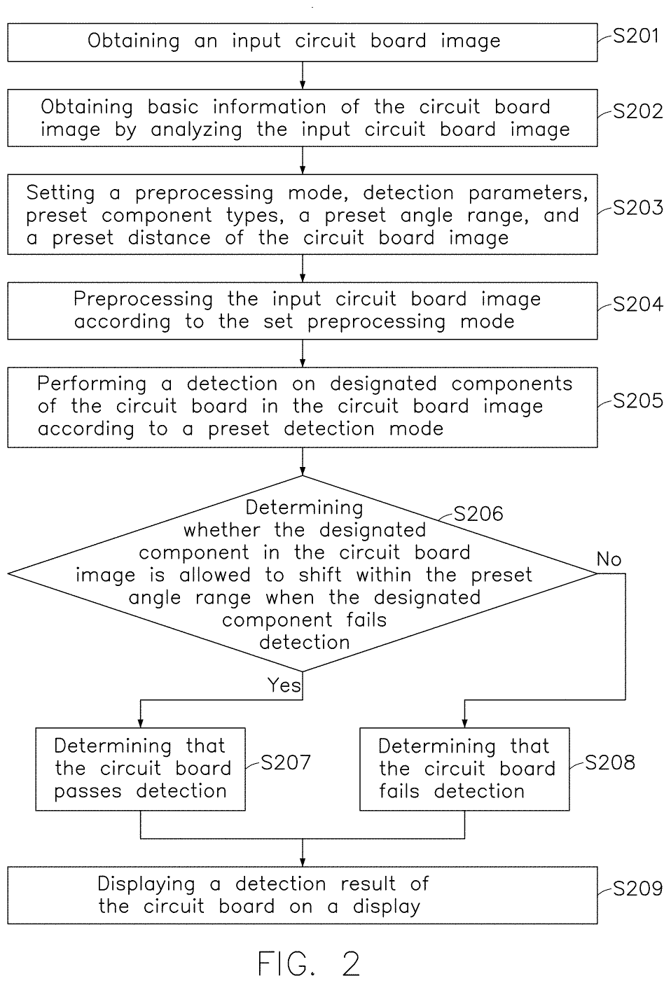

FIG. 2 shows a flowchart of a circuit board detection method according to an embodiment of the present disclosure. According to different requirements, the order of blocks in the flowchart can be changed, and some blocks can be omitted or combined.

At block S201, an input circuit board image is obtained.

In one embodiment, the circuit board image is a circuit board image to be detected input by the terminal device 2.

In another embodiment, at block S201, a circuit board detection request sent by the terminal device 2 is received, and a circuit board image to be detected is obtained from a circuit board image library stored in a memory.

At block S202, basic information of the circuit board image is obtained by analyzing the input circuit board image.

In one embodiment, the basic information of the circuit board image includes, but is not limited to, a material number of the circuit board, a model of a device where the circuit board is located, and position information on the circuit board.

At block S203, a preprocessing mode, detection parameters, preset component types, a preset angle range, and a preset distance of the circuit board image are set.

In one embodiment, the preprocessing mode includes, but is not limited to, contrast enhancement, brightness, color space conversion, super-resolution reconstruction, and binarization processing. The detection parameters are parameters of a deep learning model, such as a convolutional neural network model, and the parameters of the convolutional neural network model may include a weight, a convergence value, a learning rate, and the like. The preset component types are preset component types corresponding to a non-silkscreened component in the circuit board image. The preset angle range is an angle range greater than a preset angle. In one embodiment, the preset angle is 7 degrees. The preset distance is a pixel distance, that is, a number of shifted pixels. In one embodiment, the preset distance corresponding to silkscreened components is 1.13px, and the preset distance corresponding to the non-screened components is 0.27px.

At block S204, the input circuit board image is preprocessed according to the set preprocessing mode.

In one embodiment, the input circuit board image is preprocessed according to one or more set preprocessing modes so as to improve the contrast, brightness, saturation and/or resolution of the circuit board image.

At block S205, a detection is performed on designated components of the circuit board in the circuit board image according to a preset detection mode.

In one embodiment, the designated components include the silkscreened components and/or the non-silkscreened components. When the designated component is the silkscreen component, the preset detection mode is to detect the silkscreen component according to a target detection method. When the designated component is the non-silkscreen component, the preset detection mode is to detect the non-silkscreen component according to a residual network (ResNet) classification method and a semantic segmentation method.

In one embodiment, the target detection method is used to perform target detection on the circuit board image to determine whether the circuit board contains silkscreen components. The silkscreened component includes a circuit board region having a silkscreened portion and an electronic component.

In one embodiment, the target detection method is to input the circuit board image into a trained Faster R-CNN (Deep Convolutional Neural Network) model, and detect the circuit board image through the Faster R-CNN model to determine whether the circuit board image contains a silkscreened portion. The silkscreened portion may be numbers, letters, symbols, etc. When it is determined that the circuit board image contains silkscreened portions such as numbers, letters, and symbols, it is determined that the circuit board contains silkscreened components, and the region containing the silkscreened portions is determined as a location containing the silkscreened components. When it is determined that the circuit board image does not include silkscreened portions, then it is determined that the circuit board does not include silkscreened components.

In one embodiment, the Faster R-CNN model is further used to detect whether the circuit board image contains electronic components that do not have silkscreened portions. Electronic components that do not have silkscreened portions are regions with irregular shapes. When it is determined that the circuit board image contains electronic components that do not have silkscreened portions, then it is determined that the circuit board contains non-silkscreened components, and the regions containing electronic components with irregular shapes are determined as the locations of the non-silkscreened components. When it is determined that the circuit board image does not include electronic components without silkscreened portions, then it is determined that the circuit board does not include non-silkscreened components. When the circuit board contains neither silkscreened components nor non-silkscreened components, then it is determined that the circuit board fails detection.

In one embodiment, when the circuit board in the circuit board image contains silkscreened components, the silkscreened components are detected according to the target detection method.

In one embodiment, a silkscreen region image corresponding to the silkscreen component is detected and extracted, the extracted silkscreen region image is input into a first convolutional neural network model, and whether the silkscreen region has defects is determined based on the first convolutional neural network model. In one embodiment, the first convolutional neural network model is a Faster R-CNN model that has been trained based on a data set.

In one embodiment, the Faster R-CNN model includes a region proposal network (RPN) for generating a region proposal and a Fast R-CNN deep convolutional neural network for defect detection in the region proposal. The region proposal network is a fully convolutional network with a main function to calculate and analyze convolutional layer features of the image, and then generate rectangular frames for different defect types under different image ratios. Coordinates of the rectangular frames are represented by four parameters, which are x and y coordinates of a center point of the frame, a height h, and a width w. The same image will produce multiple rectangular frames, and the rectangular frames may be defective regions (region proposals). Fast R-CNN calculates and analyzes the region proposals output by the region proposal network, filters out redundant or wrong region proposals, and obtains an optimal rectangular frame and category score, which are a final detection result.

In one embodiment, the image of the silk screen region is first scaled to an image with a fixed resolution of M*N, and then the image with a resolution of M*N is input to the Faster R-CNN model. Then, feature maps of the M*N image are extracted through convolutional layers. In one embodiment, there are thirteen convolutional layers, 13 rectification layers, and four pooling layers. Then, the M*N image is subjected to convolution operation through the region proposal network, an anchor point is determined through Softmax (normalization), and the anchor point is corrected through a border regression operation to obtain an accurate region proposal. Then, the feature maps and region proposals are collected through a region of interest (RoI) pooling layer, and the feature maps of the region proposals are extracted. Finally, a category of the region proposal is determined through a feature mapping calculation of the region proposal, and then the border regression operation is performed again to obtain a final precise position of a detection frame.

In one embodiment, when the circuit board in the circuit board image contains non-silkscreened components, the non-silkscreened components of the circuit board in the circuit board image are detected according to a residual network classification method and a semantic segmentation method.

In one embodiment, the non-silkscreened component is first classified by the residual network classification method, and then whether the non-silkscreened component belongs to a preset component type is determined. When the non-silkscreened component does not belong to the preset component type, then it is determined that the circuit board image fails detection.

In one embodiment, when the non-silkscreened component belongs to the preset component type, the image of the non-silkscreened component is input into a second convolutional neural network model, and whether the non-silkscreened component has defects is determined based on the second convolutional neural network model, so as to detect the non-silkscreened component according to the semantic segmentation method. In one embodiment, the second convolutional neural network model is a DeepLabV3+ model that has been trained based on a data set.

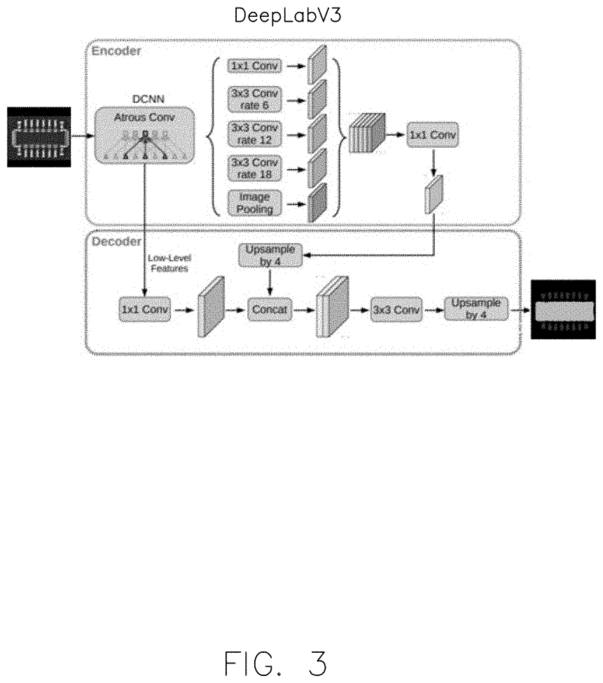

Referring to FIG. 3, in one embodiment, the DeepLabV3+ model includes an encoder and a decoder. A front end of the encoder adopts hole convolution to obtain shallow low-level features, and then transmits the shallow low-level features to a front end of the decoder. A back end of the encoder adopts atrous spatial pyramid pooling (ASPP) to obtain deep and advanced feature information. A spatial pyramid pooling module includes one 1*1 convolutional layer, three 3*3 hole convolutions, and one global average pooling layer (image pooling). The features output by the four layers are spliced together (contact), and a 256-channel feature map is obtained through a 1*1 convolutional layer fusion, that is, the deep advanced feature information, and output_stride is 16. Output_stride is a decoder for a ratio of a resolution of the input image to a resolution of the output feature map. The decoder receives the deep advanced feature information and performs bilinear up-sampling on the deep advanced feature information to obtain a 256-channel feature with an output_stride of 4. At the same time, the decoder uses a 1*1 convolution reduction channel to reduce a shallow low-level feature channel to 256. The decoder further splices the processed deep advanced features and shallow low-level features, then uses a 3*3 convolutional layer to further fuse the features, and obtains a deep learning segmentation prediction result through bilinear 4-fold sampling. Among them, segmented regions in the prediction result can be marked by different colors. Finally, according to the segmentation prediction result, whether there is a defect in the non-silkscreened component is determined. When a contour of the segmented element is different from a standard contour, then it is determined that the non-silkscreened component has a defect. When the contour of the segmented component is the same as the standard contour, then it is determined that the non-silkscreened component does not have defects.

At block S206, in response that the designated component fails the detection, whether the designated component in the circuit board image is allowed to shift within the preset angle range is determined.

In one embodiment, when the silkscreened component and/or the non-silkscreened component fails detection, the circuit board image is rotated by the preset angle range, and then the silkscreened component in the rotated circuit board image is detected according to the target detection method and/or the non-silkscreen component in the rotated circuit board image is detected according to the semantic segmentation method. When it is detected that there are no defects in the silkscreened component and/or the non-silkscreened component in the rotated circuit board image, then it is determined that the designated component is allowed to shift within the preset angle range, and block S207 is implemented. When it is detected that the silkscreened component and/or the non-silkscreen component in the rotated circuit board image fail detection, then it is determined that the designated component is not allowed to shift within the preset angle range, and block S208 is implemented.

In another embodiment, the rotated circuit board image is obtained by recapturing the circuit board image at the rotated angle.

It should be noted that positions of the silkscreened components and the non-silkscreened components in the circuit board image that are shifted within the preset angle range are not regarded as defects, thereby improving the detection accuracy of the circuit board.

At block S207, the circuit board is determined to pass detection.

At block S208, the circuit board is determined to fail detection.

At block S209, a detection result of the circuit board is displayed on a display.

In one embodiment, when it is determined that the circuit board has passed detection, the text “Detection passed” is displayed on the display. When it is determined that the circuit board fails detection, the text “Detection failed” is displayed on the display, and the defective circuit board image is displayed. The defective region is marked with a rectangular frame on the circuit board image, and a type of defect is marked with a number.

The method further includes sending the detection result of the circuit board to the terminal device 2.

In another embodiment, when it is determined that the designated component, that is, the silkscreened component and the non-silkscreened component, are allowed to shift within the preset angle range, the method further includes determining whether the designated component in the circuit board image is allowed to shift within a preset distance, that is, whether the silkscreened component is allowed to shift within 1.23 px, and whether the non-silkscreened component is allowed to shift within 0.27 px.

For example, when it is determined that the silkscreened component and the non-silkscreened component are allowed to shift within the preset angle range, the silkscreened component in the circuit board image is controlled to shift by 1.23px and/or the non-silkscreened component in the circuit board image is controlled to shift by 0.27px, and then the detection result of the silkscreened component and/or the non-silkscreened component is determined according to the target detection method and/or the semantic segmentation method, respectively. When it is determined that the shifted silkscreen component and/or the shifted non-silkscreened component does not have defects, it is determined that the designated component is allowed to shift within the preset distance. When it is detected that the shifted silkscreen component and/or the shifted non-silkscreened component has defects, it is determined that the designated component is not allowed to shift within the preset distance.

In the other embodiment, the silkscreened components and/or the non-silkscreened components in the circuit board image can be controlled to move in at least one of a horizontal left direction, a horizontal right direction, a vertical up direction, and a vertical down direction. In other embodiments, the shifted circuit board image is obtained by recapturing the circuit board image at the shifted preset distance in the horizontal left direction, the horizontal right direction, the vertical up direction, and the vertical down direction.

It should be noted that the positions of the silkscreened components and non-silkscreened components in the circuit board image can be shifted by a certain angle and a certain distance within the allowable range, and are not considered as defective, thereby improving the detection accuracy of the circuit board.

In another embodiment, when it is determined that the designated component is allowed to shift within the preset distance, the method further includes determining whether the circuit board image includes solder pins.

For example, the DeepLabV3+ model is used to determine whether the circuit board image includes solder pins. When it is determined that the circuit board image includes solder pins, whether a soldering quality of the solder pins is qualified is analyzed according to an exposed region of a pad and a classification recognition algorithm. When the soldering quality of the solder pin is qualified, it is determined that the circuit board passes detection. When the soldering quality of the solder pin is unqualified, it is determined that the circuit board fails detection.

In one embodiment, the classification and recognition algorithm is a support vector data description (SVDD) algorithm. When it is determined that the circuit board image contains solder pins, whether the exposed region of the pad in the circuit board image is within a preset region is determined, and the support vector data description algorithm is used to detect whether there are abnormal solder points on the solder pin. When it is determined through the support vector data description algorithm that the exposed region of the pad is within the preset region and the solder pin does not have abnormal solder points, then it is determined that the soldering quality of the solder pin is qualified. When it is determined through the support vector data description algorithm that the exposed region of the pad is not within the preset region and/or the solder pin has abnormal solder points, it is determined that the soldering quality of the solder pin is unqualified. When it is determined that the soldering quality of the solder pin is qualified, it is determined that the circuit board passes detection. When it is determined that the soldering quality of the solder pin is unqualified, it is determined that the circuit board fails detection.

In one embodiment, a method of detecting through the support vector data description algorithm whether there are abnormal solder points includes:

Taking a plurality of normal solder points as original training samples, and mapping the original training samples to a high-dimensional feature space through nonlinear mapping;

Searching for a hypersphere (optimum hypersphere) that contains all or most of the training samples mapped to the feature space and has a smallest volume;

Taking all the solder points of the solder pins as new sample points, and determining whether the image of each new sample point in the feature space falls within the optimal hypersphere through nonlinear mapping;

If the image of the new sample point in the feature space falls on or within the optimal hypersphere, the new sample point is determined to be a normal point, and the solder point corresponding to the sample point is a normal solder point;

If the image of the new sample point in the feature space falls outside the optimal hypersphere, the new sample point is determined to be an abnormal point, and the solder point corresponding to the new sample point is a an abnormal point. The optimal hypersphere is determined by a center and radius of the hypersphere.

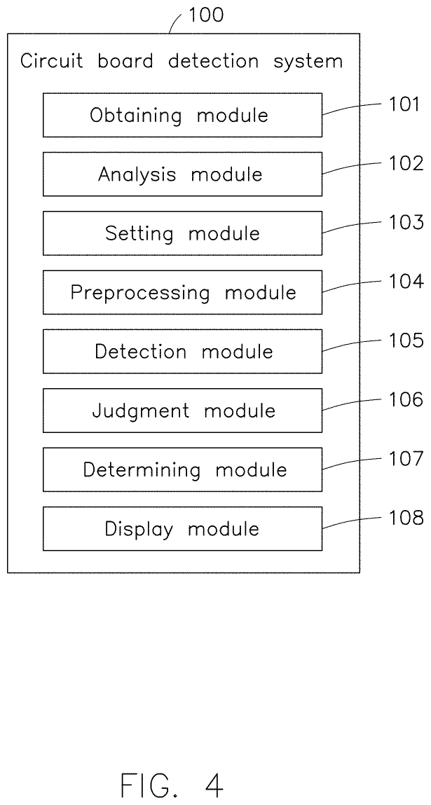

FIG. 4 shows a function module diagram of a circuit board detection system 100.

In some embodiments, the circuit board detection system 100 runs in the electronic device 1. The circuit board detection system 100 may include multiple function modules composed of program code segments. The program code segments of each function module in the circuit board detection system 100 may be stored in a memory of the electronic device 1 and executed by at least one processor of the electronic device 1.

In one embodiment, the circuit board detection system 100 includes an obtaining module 101, an analysis module 102, a setting module 103, a preprocessing module 104, a detection module 105, a judgment module 106, a determining module 107, and a display module 108.

The obtaining module 101 is used to obtain an input circuit board image.

The analysis module 102 is used to analyze the input circuit board image to obtain basic information of the circuit board image.

The setting module 103 is used to set a preprocessing mode, detection parameters, a preset component type, a preset angle range, and a preset distance of the circuit board image.

The preprocessing module 104 is configured to preprocess the input circuit board image according to the set preprocessing mode.

The detection module 105 is configured to detect the designated components of the circuit board in the circuit board image according to a preset detection method.

The judgment module 106 is used for judging whether the designated component in the circuit board image is allowed to shift within a preset angle range when the designated component fails detection.

The determining module 107 is configured to determine that the circuit board passes detection when the designated component passes detection or when it is determined that the designated component in the circuit board image is allowed to shift within the preset angle range, and determine that the circuit board fails detection when the designated component fails detection or when it is determined that the designated component in the circuit board image is not allowed to shift within the preset angle range.

The display module 108 is used to display a detection result of the circuit board on a display.

In another embodiment, when it is determined that the designated component is allowed to shift within the preset angle range, the determining module 106 is further configured to determine whether the designated component in the circuit board image is allowed to shift within a preset distance. When it is determined that the designated component in the circuit board image is allowed to shift within the preset distance, the determining module 107 determines that the circuit board passes detection. When it is determined that the designated component in the circuit board image is not allowed to shift within the preset distance, the determining module 107 determines that the circuit board fails detection.

In another embodiment, when it is determined that the designated component in the circuit board image is allowed to shift within the preset distance, the determining module 106 is further configured to determine whether the circuit board image includes solder pins. When it is determined that the circuit board image contains solder pins, the judgment module 106 is further configured to analyze whether a soldering quality of the solder pins is qualified according to an exposed region of a pad and a classification recognition algorithm. When the soldering quality of the solder pin is qualified, the determining module 107 determines that the circuit board passes detection. When the soldering quality of the solder pin is unqualified, the determining module 107 determines that the circuit board fails detection.

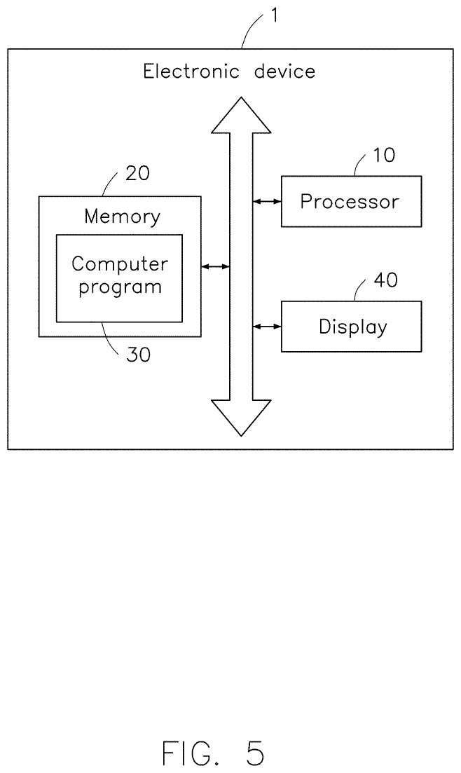

FIG. 5 shows a schematic diagram of an electronic device 1.

The electronic device 1 includes, but is not limited to, a processor 10, a memory 20, a computer program 30 stored in the memory 20 and executed by the processor 10, and a display 40. The computer program 30 may be a circuit board detection program. The processor 10 may implement the blocks in the circuit board detection method, such as blocks S201-S209 shown in FIG. 2, when the computer program 30 is executed. Alternatively, when the processor 10 executes the computer program 30, the functions of the function modules in the circuit board detection system 100, such as the modules 101-108 in FIG. 4, are implemented.

Those skilled in the art can understand that the schematic diagram in FIG. 5 is only an example of the electronic device 1 and does not constitute a limitation on the electronic device 1. It may include more or less components than those shown in the figure, a combination of certain components, or have different components. For example, the electronic device 1 may also include input and output devices, network access devices, buses, and so on.

The processor 10 may be a central processing unit, other general-purpose processor, digital signal processor, application specific integrated circuit, ready-made programmable gate array, or other programmable logic device, discrete gate or transistor logic device, discrete hardware component, etc. The general-purpose processor may be a microprocessor or the processor 10 may also be any conventional processor, etc. The processor 10 is the control center of the electronic device 1 and connects various parts of the entire electronic device 1 with various interfaces and lines.

The memory 20 may be used to store the computer program 30 and/or modules. The processor 10 executes the computer programs and/or modules stored in the memory 20. In addition, the memory 20 may include volatile and non-volatile memories, such as hard disks, internal memory, plug-in hard disks, smart memory cards, secure digital cards, flash memory cards, at least one disk storage device, flash memory device, or other storage device. The display 40 may be a liquid crystal display or an organic light-emitting diode display.

The circuit board detection method and electronic device provided by the present disclosure can detect the appearance of the circuit board according to a deep learning model and re-judge the detection result of the deep learning model, thereby effectively improving the detection accuracy of the circuit board.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A circuit board detection method comprising:
obtaining an input circuit board image;
performing a detection on designated components of a circuit board in the circuit board image according to a preset detection method, the designated components comprising one or both of silkscreened components and non-silkscreened components;
in response that one of the designated components fails the detection, determining whether the designated component in the circuit board image that fails the detection is allowed to shift within a preset angle range; and
in response that the designated component that fails the detection is allowed to shift within the preset angle range, determining that the circuit board passes the detection.

2. The circuit board detection method of claim 1, wherein:
in response that the designated component is a silkscreened component, determining the preset detection method to be a target detection method; and
in response that the designated component is a non-silkscreened component, determining the preset detection method to be a semantic segmentation method.

3. The circuit board detection method of claim 1, further comprising:
in response that the designated component is allowed to shift within the preset angle range, determining whether the designated component is allowed to shift within a preset distance; and
in response that the designated component is allowed to shift within the preset distance, determining that the circuit board passes the detection.

4. The circuit board detection method of claim 3, further comprising:
in response that the designated component is allowed to shift within the preset distance, determining whether the circuit board image comprises solder pins;
in response that the circuit board image comprises the solder pins, determining whether a soldering quality of the solder pins is qualified according to an exposed region of a pad and a classification recognition algorithm; and
in response that the soldering quality of the solder pin is qualified, determining that the circuit board passes the detection.

5. The circuit board detection method of claim 4, further comprising:
obtaining basic information of the circuit board image by analyzing the input circuit board image; and
setting a preprocessing mode, detection parameters, a preset component type, the preset angle range, and the preset distance of the circuit board image.

6. The circuit board detection method of claim 5, further comprising:
preprocessing the input circuit board image according to the set preprocessing mode.

7. The circuit board detection method of claim 1, further comprising:
displaying a detection result of the circuit board on a display.

8. The circuit board detection method of claim 2, wherein the silkscreen component is detected according to the target detection method by:
detecting and extracting a silkscreen region image corresponding to the silkscreen component; and
inputting the extracted silkscreen region image into a first convolutional neural network model, and determining whether the silkscreen region has defects based on the first convolutional neural network model.

9. The circuit board detection method of claim 2, wherein the non-silkscreen component is detected according to the semantic segmentation method by:
inputting an image of the non-silkscreened component into a second convolutional neural network model; and
determining whether the non-silkscreened component has defects based on the second convolutional neural network model.

10. An electronic device comprising:
a processor;
a display; and
a memory storing a plurality of instructions, which when executed by the processor, cause the processor to:
obtain an input circuit board image;
perform a detection on designated components of a circuit board in the circuit board image according to a preset detection method, the designated components comprising one or both of silkscreened components and non-silkscreened components;
in response that one of the designated components fails the detection, determine whether the designated component in the circuit board image that fails the detection is allowed to shift within a preset angle range; and
in response that the designated component that fails the detection is allowed to shift within the preset angle range, determining that the circuit board passes the detection.

11. The electronic device of claim 10, wherein:
in response that the designated component is a silkscreened component, determine the preset detection method to be a target detection method; and
in response that the designated component is a non-silkscreened component, determine the preset detection method to be a semantic segmentation method.

12. The electronic device of claim 10, wherein the processor is further configured to:
in response that the designated component is allowed to shift within the preset angle range, determine whether the designated component is allowed to shift within a preset distance; and
in response that the designated component is allowed to shift within the preset distance, determine that the circuit board passes the detection.

13. The electronic device of claim 12, wherein the processor is further configured to:
in response that the designated component is allowed to shift within the preset distance, determine whether the circuit board image comprises solder pins;
in response that the circuit board image comprises the solder pins, determine whether a soldering quality of the solder pins is qualified according to an exposed region of a pad and a classification recognition algorithm; and
in response that the soldering quality of the solder pin is qualified, determine that the circuit board passes the detection.

14. The electronic device of claim 13, wherein the processor is further configured to:
obtain basic information of the circuit board image by analyzing the input circuit board image; and
set a preprocessing mode, detection parameters, a preset component type, the preset angle range, and the preset distance of the circuit board image.

15. The electronic device of claim 14, wherein the processor is further configured to:
preprocess the input circuit board image according to the set preprocessing mode.

16. The electronic device of claim 10, wherein the processor is further configured to:
display a detection result of the circuit board on the display.

17. The electronic device of claim 11, wherein the processor detects the silkscreen component according to the target detection method by:
detecting and extracting a silkscreen region image corresponding to the silkscreen component; and
inputting the extracted silkscreen region image into a first convolutional neural network model, and determining whether the silkscreen region has defects based on the first convolutional neural network model.

18. The electronic device of claim 11, wherein the processor detects the non-silkscreen component according to the semantic segmentation method by:
inputting an image of the non-silkscreened component into a second convolutional neural network model; and
determining whether the non-silkscreened component has defects based on the second convolutional neural network model.
